(19) United States
(12) Patent Application Publication
(10) Pub. No.: US 2025/0112960 A1
(43) Pub. Date: Apr. 3, 2025

(54) AUTOMATIC REMEDIATION OF A NETWORK COMPONENT CONFIGURATION

(71) Applicant: Lenovo Enterprise Solutions (Singapore) Pte Ltd., Singapore (SG)

(72) Inventors: Md Kamrul Hasan, Romansville, PA (US); Eric R. Kern, Chapel Hill, NC (US); Mahesh Bharadwaj, Melbourne (AU); David D. Seltzer, Petoskey, MI (US); Robert Furda, Bratislava (SK)

(21) Appl. No.: 18/478,722

(22) Filed: Sep. 29, 2023

(51) Int. Cl. H04L 9/40; H04L 41/08; H04L 41/082

(52) U.S. Cl. CPC H04L 63/20; H04L 41/082; H04L 41/0886; H04L 63/0263; H04L 63/1433

(57) ABSTRACT

A computer program product includes program instructions configured to be executable by a processor to cause the processor to perform various operations. The operations include identifying a network component within a network infrastructure, wherein the network component operates with a current configuration of network security parameters. The operations further include periodically accessing the current configuration of network security parameters for the network component, accessing a most-recent authenticated configuration of network security parameters for the network component, identifying that the current configuration of the network component differs from the most-recent authenticated configuration of the network component, and automatically remediating the current configuration of the network component. A corresponding method may include the steps implementing the operations.

### BACKGROUND

The present disclosure relates to computer network security systems, including management of network component configurations.

### Background of the Related Art

Network infrastructure includes a variety of network components including hardware devices, software applications and network services within a network or networks that enable network communication, operations, management and/or connectivity of the network or networks. A network security system, such as a perimeter network firewall, may be implemented to accept desired network traffic and rejected undesired network traffic. However, a perimeter network firewall and other network security systems may be subject to an unintentional misconfiguration and/or a malicious attack. With an ineffective configuration, the perimeter network firewall and/or other network security systems may not serve to protect the network as intended.

### BRIEF SUMMARY

One embodiment provides a computer program product comprising a non-volatile computer readable medium and non-transitory program instructions embodied therein, the program instructions being configured to be executable by a processor to cause the processor to perform various operations. The operations comprise identifying a network component within a network infrastructure, wherein the network component operates with a current configuration of network security parameters. The operations further comprise periodically accessing the current configuration of network security parameters for the network component, accessing a most-recent authenticated configuration of network security parameters for the network component, identifying that the current configuration of the network component differs from the most-recent authenticated configuration of the network component, and automatically remediating the current configuration of the network component.

One embodiment provides a method comprising identifying a network component within a network infrastructure, wherein the network component operates with a current configuration of network security parameters. The method further comprises periodically accessing the current configuration of network security parameters for the network component, accessing a most-recent authenticated configuration of network security parameters for the network component, identifying that the current configuration of the network component differs from the most-recent authenticated configuration of the network component, and automatically remediating the current configuration of the network component.

### BRIEF DESCRIPTION OF THE SEVERAL VIEWS OF THE DRAWINGS

FIG. 1 is a diagram of a system including network infrastructure and a computing system for monitoring and management of network components in the network infrastructure.

FIG. 2 is diagram of a computer that may be representative of the computing system or a compute node within the same network as the network infrastructure.

FIG. 3 is diagram of a network switch that is a network component of the network infrastructure.

FIG. 4 is a flowchart of operations according to some embodiments.

### DETAILED DESCRIPTION

One embodiment provides a computer program product comprising a non-volatile computer readable medium and non-transitory program instructions embodied therein, the program instructions being configured to be executable by a processor to cause the processor to perform various operations. The operations comprise identifying a network component within a network infrastructure, wherein the network component operates with a current configuration of network security parameters. The operations further comprise periodically accessing the current configuration of network security parameters for the network component, accessing a most-recent authenticated configuration of network security parameters for the network component, identifying that the current configuration of the network component differs from the most-recent authenticated configuration of the network component, and automatically remediating the current configuration of the network component.

Network infrastructure may include a wide variety of network components including hardware devices, software applications and network services within a network or networks that enable network communication, operations, management and/or connectivity of the network or networks. Non-limiting examples of network components that are hardware devices include network routers, network switches, hubs, proxy servers, repeaters, gateways, bridges, modems, Intrusion Detection Systems (IDSs), Intrusion Prevention Systems (IPSs), and perimeter network firewalls. Non-limiting examples of network components that are software applications include monitoring and management tools, Internet Protocol (IP) tables, and software-defined firewalls, where the latter include operating system (OS) firewalls, application firewalls, and hypervisor firewalls. Embodiments can be applied to any network infrastructure regardless of the size of the network environment and/or the number or types of network components.

Embodiments may identify one or more of the network components within a network infrastructure. Optionally, embodiments may identify a plurality of the network components or even all of the network components within the network infrastructure. Furthermore, embodiments may identify network components of a particular one or more type, in one or more locations or within a boundary of the network or networks. For each identified network component in the network infrastructure, the computing system may collect and/or store identifying information such as an Internet Protocol (IP) Address, Domain Name System (DNS) name, component type, operating system type and/or operating system version. The identifying information for each network component may be stored in a separate record of a database or list.

In some embodiments, a computing system may perform the operation of identifying the network components of the network infrastructure. While the computing system may be located within the same network as the network components, some embodiments of the computing system may be located in an external network. For example, the computing system may be operated by a service provider that communicates with the network infrastructure over a wide area network (WAN) such as the Internet to provide a network monitoring service. Optionally, the computing system may include a computer program product that is performed on a remote server, a compute node within the network with the network infrastructure, or in a cloud computing environment. However, regardless of the location of the computing system that performs the operations, the computing system should be able to access the identified network components that are within the network infrastructure.

In some embodiments, the computing system may communicate with a system management node within the network that includes the network infrastructure, wherein the system management node may be in further communication with one or more of the network components. For example, one or more of the identified network components may include a management controller, such as a baseboard management controller, that is in communication the system management node. Accordingly, the system management node and/or local management controllers on the network components may assist with identifying the network components, accessing the current configuration of network security parameters for the network component, accessing a most-recent authenticated configuration of network security parameters for the network component, and/or automatically remediating the current configuration of the network component.

Each identified network component may operate with a current configuration of network security parameters. The network security parameters may include, without limitation, policies, rules, processes and practices that are designed to prevent, detect and monitor unauthorized access, misuse or modification of a network, network resources or data available within the network. Specific examples of network security parameters of a firewall configuration may include the content of an Access Control List (ACL), a rule or policy, an authorized user, a role of an authorized user, and a DNS (Domain Name System) server.

A firewall is a type of network security system that is capable of enforcing network security policies by monitoring and controlling network traffic to, from or within a network based on a predetermined firewall configuration. The firewall configuration may include a collection of one or more security rules or filters that govern the operation of the firewall. Firewalls may be categorized as either a network-based firewall that is positioned between two networks or a host-based firewall that is implemented directly on a host device, such as compute node. One example of a host-based firewall is a firewall service that is part of a host operating system.

Firewalls may also be described according to various firewall types, such as a packet filter, connection tracking and application layer. A packet filter type of firewall inspects packets transferred between computers and maintains an access-control list that identifies a portion of the packet to be inspected and the action to be taken based on the content of the inspected portion of the packet. For example, packets may be filtered on the basis of source and/or destination Internet Protocol addresses, the protocol used by the packet, and/or source and/or destination ports. A firewall with a packet filter may take action to silently discard the packet, discard the packet with a response sent to the sender (perhaps via Internet Control Message Protocol or Transmission Control Protocol reset), or forward the packet to the next hop. Furthermore, a connection tracking type of firewall may further maintain knowledge of specific conversations between endpoints, which may involve storing the port numbers that the source and destination IP addresses are using for the conversation. An application layer type of firewall can better understand certain applications and protocols, such as File Transfer Protocol (FTP), Domain Name System (DNS), and/or Hypertext Transfer Protocol (HTTP), so that the application layer firewall can identify unwanted applications or services using a nonstandard port or detect abuse of an allowed protocol. An application layer firewall may also provide unified security management, such as enforcing use of encrypted DNS or a virtual private network (VPN). Further endpoint-specific application firewalls may also be identified and monitored in accordance with some embodiments.

In some embodiments, the computing system may periodically access the current configuration of network security parameters for the network component either by exchanging a query and response directly with the network component, or by exchanging a query and response with the system management node that obtains the current configuration from the network component. The period of time or intervals between sequential accesses of the current configuration may be fixed or variable and may be configurable for each of the identified network components. Furthermore, each instance of access to the current configuration may be initiated by the computing system sending a request for the current configuration or by the network component or system management node pushing the current configuration to the computing system. In implementations in which the computing system has identified a plurality of network components, the computing system may periodically access the current configuration of network security parameters for each of the identified network components. Access to a network component configuration may include collecting, obtaining or reading some or all of the network security parameters that are included in the configuration of the network component. The network component configurations are preferably accessed or obtained using a secure communication protocol, such as the Secure File Transfer Protocol (SFTP), via the system management node such as LENOVO® XCLARITY™ Administrator (LXCA)/XCLARITY™ Controller (XCC) from Server/Hyper-visor, or Secure Shell Protocol (SSH).

In some embodiments, a most-recent authenticated configuration of network security parameters for the network component may be stored by the computing system or stored by the network component. If the most-recent authenticated configuration of the network is stored by the computing system, then the most-recent authenticated configuration may be stored in, or in association with, the same database record that stores the identifying information for the network component. If the most-recent authenticated configuration of the network component is stored by the network component, the computing system may access the most-recent authenticated configuration in the same or similar manner that the computing system uses to access the current configuration of the network component.

In some embodiments, the most-recent authenticated configuration of the network component may be updated in response to detecting that the current configuration of the network component has been changed by an authorized user. For example, the computing system or the system management node may maintain a change management record including a history of configuration changes entered by an authorized user. Accordingly, the computing system may determine whether any one or more of the network security parameters of a current configuration are authenticated by comparing the current values of the one or more network security parameters to the most-recent authenticated configuration of the network component and/or searching the change management record for evidence that the current values were entered by an authorized user.

After accessing both the current configuration and the most-recent authenticated configuration, embodiments may identify or determine whether the current configuration of the network component differs from the most-recent authenticated configuration of the network component. A difference between the current configuration and the most-recent authenticated configuration for the network component indicates that the current configuration has been modified in some manner other than by the actions of an authorized user. The difference between the current configuration and the most-recent authenticated configuration for the network component may be a change in the value of one or more existing network security parameters, addition of one or more new network security parameter, or deletion of one or more existing network security parameter. For example, if the most-recent authenticated configuration of the network component includes a firewall rule that accepts network traffic from a first IP address but the current configuration of the firewall rule now accepts network traffic from a second IP address rather than the first IP address, then the change in the value of the IP address in the firewall rule may be the result of some suspicious activity. In another example, if the current configuration of the network component includes a new firewall rule that is not present in the most-recent authenticated configuration, then the new firewall rule, which may accept network traffic from a specified IP address or negate other existing firewall rules, may be the result of some suspicious activity. In a further example, if the current configuration of the network component no longer includes a firewall rule that was present in the most-recent authenticated configuration, then the absence of the firewall rule may be the result of some suspicious activity and may have the effect of enabling the network component to accept network traffic that would be rejected by the most-recent authenticated configuration.

Embodiments include automatically remediating the current configuration of the network component. The term “remediating” refers to providing a remedy or correction. In one option, automatically remediating the current configuration may include automatically restoring the most-recent authenticated configuration on the network component or causing the network component to restore or revert to the most-recent authenticated configuration. In another option, the operation of identifying that the current configuration of the network component differs from the most-recent authenticated configuration of the network component may include identifying, for one or more of the network security parameters, that the network security parameter has a current value that differs from an authenticated value of the network security parameter in the most-recent authenticated configuration. Accordingly, the operation of automatically remediating the current configuration of the network component may include automatically remediating the identified network security parameter. For example, the identified network security parameter may be remediated by replacing the current value of the identified network security parameter with the authenticated value of the identified network security parameter. In a still further option, if the current configuration is identified as having an additional network security parameter, such as an additional firewall rule, then automatically remediating the current configuration may include deleting the additional network security parameter. For example, if the additional or new firewall rule accepts network traffic that is rejected by the firewall rules set out in the most-recent authenticated configuration of the network component, deleting the additional firewall rule will cause the firewall to return to a condition that rejects the network traffic.

In some embodiments, the operations may further include determining whether the current configuration of the network component causes a network security vulnerability. If the current configuration of the network component is determined to cause a network security vulnerability, then the operation of automatically remediating the current configuration of the network component may includes initiating a software upgrade of the network component. In one example, the operations may include monitoring a volume of the network traffic that is accepted only as a result of the new firewall rule and searching a security advisory database to determine whether there is a security advisory record identifying a vulnerability associated with the new firewall rule and suggesting a software upgrade. Accordingly, the suggested software upgrade of the network component may be initiated in response to determining that the security advisory database includes a security advisory record identifying a vulnerability associated with the new firewall rule.

In some embodiments, the operation of identifying that the current configuration of the network component differs from the most-recent authenticated configuration of the network component may include identifying that the current configuration includes a new firewall rule that is not included in the most-recent authenticated configuration. When such a new firewall rule is identified and that new firewall rule is not included in the most-recent authenticated configuration, the operations may further include monitoring a volume of the network traffic that is accepted only as a result of the new firewall rule, and throttling, filtering or blocking the network traffic in response to detecting a sudden burst in the volume of the network traffic. In one option, any network traffic that is accepted under a firewall rule included in the most-recent authenticated configuration of the network component may be prioritized. In another option, the operations may include initiating the suggested software upgrade to a plurality of network components within the network infrastructure.

The identified difference between the current configuration and the most-recent authenticated configuration of the network component may include any difference in the set of network security parameters within the configuration. Non-limiting examples of these differences may include a rule that allows use of an insecure protocol of communication with network component, a rule allowing an external Remote Desktop Protocol connection, a changed/additional/deleted firewall rule, an elevated user privilege, and a DNS server change.

In some embodiments, the operations may further include automatically generating and sending an alert or notification in response to identifying that the current configuration of the network component differs from the most-recent authenticated configuration of the network component. The alert may be in various forms, such as an email message directed to an administrative person, a Short Message Service (SMS) message (aka text message) directed to the administrative person, a pop up screen in a graphical user interface of the computing system, or a work ticket entry in a ticketing system. For an identified misconfiguration, configuration change or suspicious activities, an alert may be generated and communicated via a selected or configured form so that an administrative person and/or a designated team may be alerted to the condition.

Firewalls are used to control incoming or outgoing traffic of a network infrastructure, and embodiment may assess the configuration of various types of firewalls to identify intentional or unintentional changes or misconfigurations. An unintentional change to a firewall configuration might occur, for example, during creation of a firewall rule if a system administrator (a person) enters an incorrect address, subnet or port for a source or destination. Non-limiting examples of a misconfiguration (i.e., an incorrect configuration) may include a rule that allows any network traffic or a rule that allows insecure protocols like File Transfer Protocol (FTP), Lightweight Directory Access Protocol (LDAP), Telnet, and HyperText Transfer Protocol (HTTP). Non-limiting examples of suspicious activity may include elevating a user privilege, DNS server change, creating a new rule on top to bypass rules below, and disabling a deny rule. The configuration of firewalls has become even more important as a result of having various types of firewalls in the network, such as perimeter network firewalls, software defined firewalls, application layer firewalls, operating system layer firewalls, hypervisor firewalls, and the like. System administrators frequently make changes in firewalls based on business requirements. Embodiments described herein may continuously or periodically monitor and evaluate firewalls for configuration changes and misconfigurations that affect the network and network security of the infrastructure.

In some embodiments, a backup of each identified network component configuration may be periodically saved. Without limitation, the backup may be saved to the network component or central storage associated with the computing system or system management node. The backup is preferably the most-recent authenticated configuration for the particular network component.

Some embodiments may utilize an artificial intelligence (AI) engine to determine or distinguish normal changes or activity from suspicious changes or activity. The AI engine may be trained to distinguish good changes or activity vs. bad changes or activity in the system. Some non-limiting examples of good changes may include changes that are approved in a change management tool, changes improving security like adding multifactor authentication, strict security policy etc. Some non-limiting examples of bad changes may include changes that do not exist in a change management tool or are not otherwise approved, creating a rule using an insecure protocol (FTP, Telnet), creating a rule that allows any<>any, and allowing external RDP (Remote Desktop Protocol) connection to an internal system.

One embodiment provides a method comprising identifying a network component within a network infrastructure, wherein the network component operates with a current configuration of network security parameters. The method further comprises periodically accessing the current configuration of network security parameters for the network component, accessing a most-recent authenticated configuration of network security parameters for the network component, identifying that the current configuration of the network component differs from the most-recent authenticated configuration of the network component, and automatically remediating the current configuration of the network component.

The foregoing computer program products may further include program instructions for implementing or initiating any one or more operations of the methods described herein. Conversely, the methods may further include any operation implemented or initiated by the computer program products.

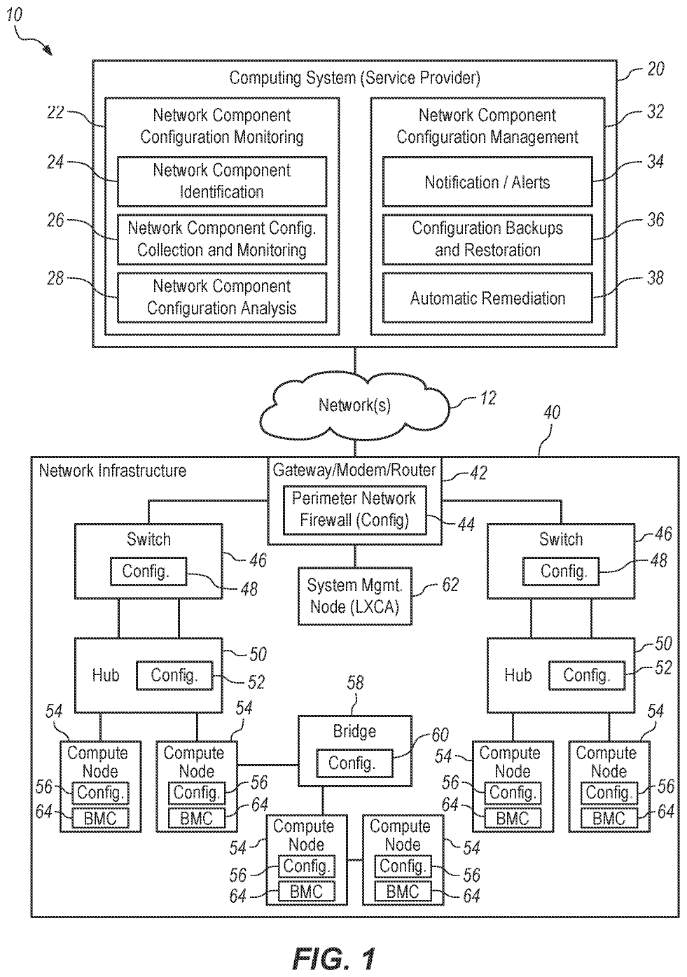

FIG. 1 is a diagram of a system 10 including network infrastructure 40 and a computing system 20 for monitoring and management of network components in the network infrastructure 40. The computing system 20 is in communication with the network infrastructure 40 over an external network 12, which may be a wide area network (WAN) such as the Internet.

The network infrastructure 40 is part of an information technology system, such as a datacenter, and includes a wide variety of network components, such as hardware devices, software applications and network services within a network or networks. The network infrastructure 40 enables network communications, operations, management and/or connectivity of other devices within the network or networks. For example, the network infrastructure 40 may be utilized in a datacenter to support network communications, operations, management and connectivity of a large number of compute nodes, such as servers, data storage devices and the like that are not shown. Rather, FIG. 1 illustrates a subset of a network or datacenter to highlight a few types of network components that may be present in the network infrastructure 40. However, the embodiments are not limited to these types of network components or to the specific network architecture illustrated.

The network architecture 40 includes a gateway, modem or router 42 that includes a perimeter network firewall 44 operating with a firewall configuration (“Config.”). The network architecture 40 further includes a pair of switches 46 that are connected to the gateway, modem or router 42, where each switch 46 includes its own configuration 48. The network architecture 40 also includes a pair of hubs 50 that are connected to the switches 46, wherein each hub 50 includes its own configuration 52. Furthermore, there are four compute nodes 54 illustrate, where each compute node 54 includes its own configuration 56 of network security parameters, which could include application firewalls, an operating system firewall and/or a hypervisor firewall. Two of the compute nodes 54 are connected to each of the hubs 50, and two other compute nodes 54 are connected to a bridge 58. The bridge 58 is connected to one of the other compute nodes 54 and includes its own configuration 60.

The system 10 may further include a system management node (LXCA) 62 and a baseboard management controller (BMC) 64 in each of the compute nodes 54. The system management node (LXCA) 62 and a baseboard management controller (BMC) 64 may, in some embodiments, participate in accessing the configurations 56 of the compute nodes 54 and providing the configurations to the computing system 20. Optionally, the system management node 62 may communicate with any or all of the network components illustrated in the network infrastructure 40 and provide requested information to the computing system 20. For example, the system management node 62 may assist the computing system 20 to identify each of the network components, obtain identifying information about each network component, obtain and/or store a most-recent authenticated configuration of the network component, and access a current configuration of each network component.

The computing system 20 is shown being external to the network that includes the network infrastructure 40, but the computing system 20 could be within that same network as the network infrastructure 40. The computing system 20 performs operations by executing program instructions that may be provided as program modules. In this embodiment, the computing system performs the operations of a network component configuration monitoring module 22 and a network component configuration management module 32. The network component configuration monitoring module 22 includes sub-modules for network component identification 24, network component configuration collection and monitoring 26, and network component configuration analysis 28. The network component configuration management module 32 includes sub-modules for notifications and alerts 34, configuration backups and restoration 36, and automatic remediation 38. Other arrangements of the modules and/or sub-modules may be envisioned to perform the operations according to one or more embodiments.

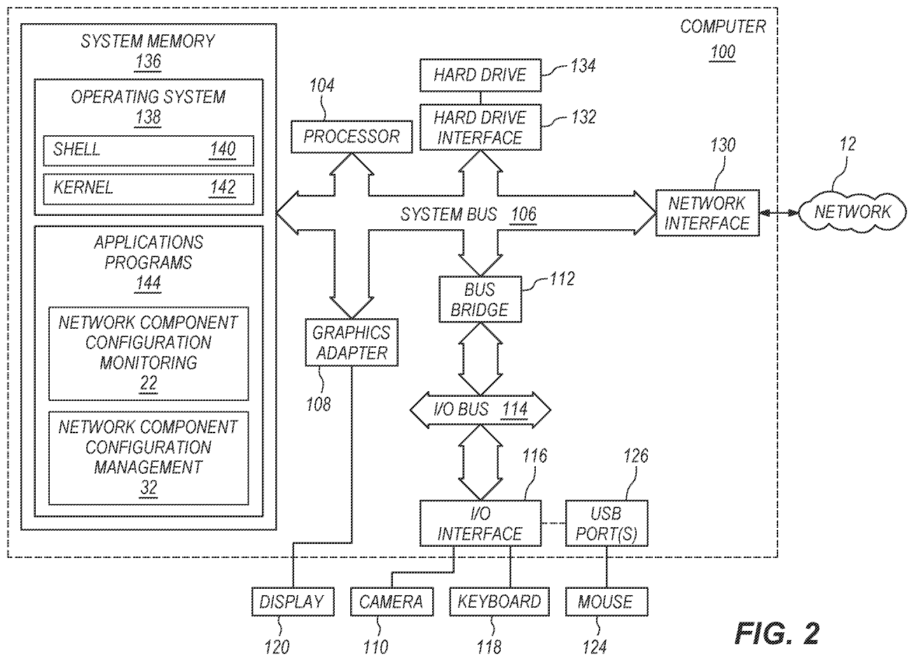

FIG. 2 is diagram of a computer 100 having an architecture that may be representative of some embodiments of the computing system 20, the system management node 62, and/or the compute nodes 54 of FIG. 1. The computer 100 includes a processor unit 104 that is coupled to a system bus 106. The processor unit 104 may utilize one or more processors, each of which has one or more processor cores. A graphics adapter 108, which drives/supports the display 120, is also coupled to system bus 106. The graphics adapter 108 may, for example, include a graphics processing unit (GPU). The system bus 106 is coupled via a bus bridge 112 to an input/output (I/O) bus 114. An I/O interface 116 is coupled to the I/O bus 114. The I/O interface 116 affords communication with various I/O devices, including a camera 110, a keyboard 118 (such as a touch screen virtual keyboard), and a USB mouse 124 via USB port(s) 126 (or other type of pointing device, such as a trackpad). As depicted, the computer 100 is able to communicate with other network devices over the network 12 using a network adapter or network interface controller 130.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as a lowest level of volatile memory in the computer 100. This volatile memory may include additional higher levels of volatile memory (not shown), including, but not limited to, cache memory, registers and buffers. Data that populates the system memory 136 may include an operating system (OS) 138 and application programs 144. If the computer 100 is representing the computing system 20, then the system memory 136 may include application programs that provide the program instructions for the network component configuration monitoring module 22 and a network component configuration management module 32.

The operating system 138 for the computer 100 may include a shell 140 for providing transparent user access to resources such as the application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 140 may be a text-based, line-oriented user interface, embodiments may support other user interface modes, such as graphical, voice, gestural, etc.

As depicted, the operating system 138 also includes the kernel 142, which may include lower levels of functionality for the operating system 138, including providing essential services required by other parts of the operating system 138 and the application programs 144. Such essential services may include memory management, process and task management, disk management, and mouse and keyboard management.

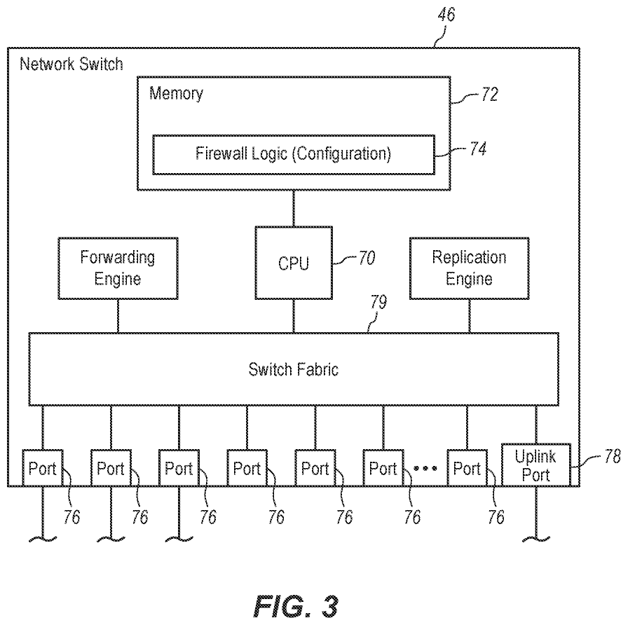

FIG. 3 is diagram of a network switch 46 that may be one of the network components of the network infrastructure 40 as shown in FIG. 1. The network switch 46 includes a central processing unit 70 and memory 72, where the central processing unit 30 may load and execute one or more applications or program modules stored in the memory 72. Along with other applications and program modules, the memory 72 stores firewall logic 74 including a firewall configuration. The firewall configuration may include any number and type of network security parameters, such as access rules that limit the IP addresses and network protocols that may be accepted by the switch. The switch has multiple local ports 76 and an uplink port 78 providing connections in the network infrastructure 40. Each of the local ports 76 (downstream ports), as well as the uplink port 78 are connected to switch fabric 79. The switch fabric 79 is used to handle network communications between the various ports 76, 78.

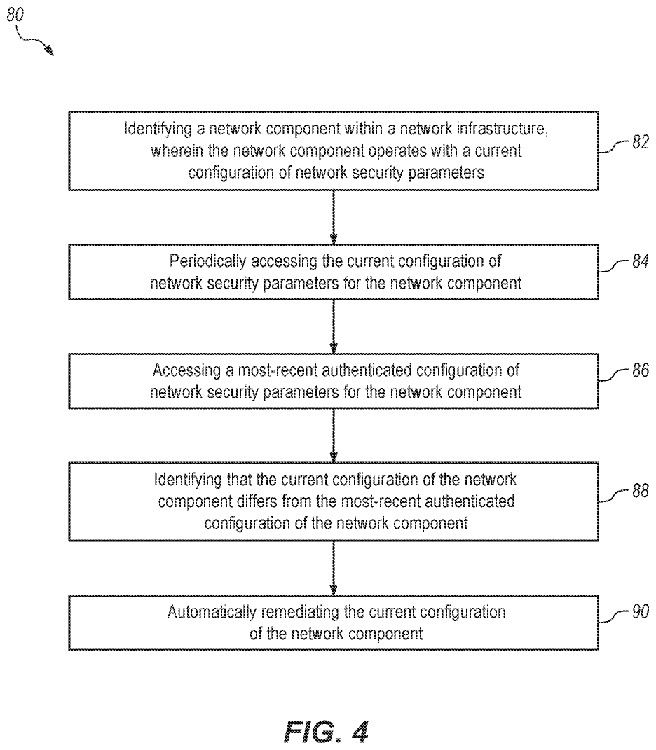

FIG. 4 is a flowchart of operations 80 according to some embodiments of a computer program product or method. Operation 82 includes identifying a network component within a network infrastructure, wherein the network component operates with a current configuration of network security parameters. Operation 84 includes periodically accessing the current configuration of network security parameters for the network component. Operation 86 includes accessing a most-recent authenticated configuration of network security parameters for the network component. Operation 88 includes identifying that the current configuration of the network component differs from the most-recent authenticated configuration of the network component. Operation 90 includes automatically remediating the current configuration of the network component.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-volatile computer readable medium and non-transitory program instructions embodied therein, the program instructions being configured to be executable by a processor to cause the processor to perform operations comprising:
identifying a network component within a network infrastructure, wherein the network component operates with a current configuration of network security parameters;
periodically accessing the current configuration of network security parameters for the network component;
accessing a most-recent authenticated configuration of network security parameters for the network component;
identifying that the current configuration of the network component differs from the most-recent authenticated configuration of the network component; and
automatically remediating the current configuration of the network component.

2. The computer program product of claim 1, wherein automatically remediating the current configuration of the network component includes automatically causing the network component to revert to the most-recent authenticated configuration.

3. The computer program product of claim 1, wherein identifying that the current configuration of the network component differs from the most-recent authenticated configuration of the network component includes identifying, for one or more of the network security parameters, that the network security parameter has a current value that differs from an authenticated value of the network security parameter in the most-recent authenticated configuration, and wherein automatically remediating the current configuration of the network component includes automatically remediating the identified network security parameter.

4. The computer program product of claim 3, wherein automatically remediating the identified network security parameter includes automatically replacing the current value of the identified network security parameter with the authenticated value of the identified network security parameter.

5. The computer program product of claim 1, the operations further comprising:
determining whether the current configuration of the network component causes a network security vulnerability, wherein automatically remediating the current configuration of the network component includes initiating a software upgrade of the network component in response to determining that the current configuration of the network component causes a network security vulnerability.

6. The computer program product of claim 1, wherein identifying that the current configuration of the network component differs from the most-recent authenticated configuration of the network component includes identifying that the current configuration includes a new firewall rule that is not included in the most-recent authenticated configuration, and wherein the new firewall rule accepts network traffic that is rejected by firewall rules set out in the most-recent authenticated configuration of the network component.

7. The computer program product of claim 6, wherein automatically remediating the current configuration of the network component includes deleting the new firewall rule.

8. The computer program product of claim 6, the operations further comprising:
monitoring a volume of the network traffic that is accepted only as a result of the new firewall rule; and
throttling, filtering or blocking the network traffic in response to detecting a sudden burst in the volume of the network traffic.

9. The computer program product of claim 8, the operations further comprising:
prioritizing network traffic that is accepted under a firewall rule included in the most-recent authenticated configuration of the network component.

10. The computer program product of claim 6, the operations further comprising:
monitoring a volume of the network traffic that is accepted only as a result of the new firewall rule;
searching a security advisory database to determine whether there is a security advisory record identifying a vulnerability associated with the new firewall rule and suggesting a software upgrade; and
initiating the suggested software upgrade of the network component in response to determining that the security advisory database includes a security advisory record identifying a vulnerability associated with the new firewall rule.

11. The computer program product of claim 10, the operations further comprising:
initiating the suggested software upgrade to a plurality of network components within the network infrastructure.

12. The computer program product of claim 1, wherein identifying that the current configuration of the network component differs from the most-recent authenticated configuration of the network component includes:
accessing a change management record including a history of configuration changes entered by an authorized user; and
determining that at least one of the network security parameters of the current configuration for the network component are not included the change management record.

13. The computer program product of claim 1, the operations further comprising:
updating the most-recent authenticated configuration of the network component in response to detecting that the current configuration of the network component has been changed by an authorized user.

14. The computer program product of claim 13, wherein the most-recent authenticated configuration of the network component is stored by the network component and/or a computing system that includes the processor.

15. The computer program product of claim 1, wherein the identified difference between the current configuration and the most-recent authenticated configuration of the network component is a rule that allows use of an insecure protocol of communication with network component.

16. The computer program product of claim 1, wherein the identified difference between the current configuration and the most-recent authenticated configuration of the network component is an elevated user privilege, a sudden DNS server change, or enabling a rule allowing an external Remote Desktop Protocol connection.

17. The computer program product of claim 1, further comprising:
automatically generating and sending an alert in response to identifying that the current configuration of the network component differs from the most-recent authenticated configuration of the network component, wherein the alert is an email message directed to an administrative person, an Short Message Service message directed to the administrative person, or a work ticket entry in a ticketing system.

18. The computer program product of claim 1, wherein the network component is a firewall selected from a perimeter network firewall, software defined firewall, application layer firewall, operating system layer firewall, and hypervisor firewall.

19. The computer program product of claim 1, the operations further comprising:
storing, for each of a plurality of network components in the network infrastructure, a record including an Internet Protocol Address, DNS name, component type, operating system type and operating system version.

20. A method, comprising:
identifying a network component within a network infrastructure, wherein the network component operates with a current configuration of network security parameters;
periodically accessing the current configuration of network security parameters for the network component;
accessing a most-recent authenticated configuration of network security parameters for the network component;
identifying that the current configuration of the network component differs from the most-recent authenticated configuration of the network component; and
automatically remediating the current configuration of the network component.
